(19) United States
(12) Patent Application Publication
(10) Pub. No.: US 2026/0062877 A1
(43) Pub. Date: Mar. 5, 2026

(54) VEHICLE-MOUNTED DROP-DOWN STORAGE SYSTEM

(71) Applicant: Edward J. Tovornik, Jr., Frederick, MD (US)

(72) Inventor: Edward J. Tovornik, Jr., Frederick, MD (US)

(21) Appl. No.: 19/311,448

(22) Filed: Aug. 27, 2025

Related U.S. Application Data
(60) Provisional application No. 63/687,545, filed on Aug. 27, 2024.

(51) Int. Cl. E01F 9/70; B60R 9/02; B60R 11/00

(52) U.S. Cl. CPC E01F 9/70; B60R 9/02; B60R 2011/0085

(57) ABSTRACT

A vehicle-mounted drop-down storage system comprises a multi-bin storage box pivotably mounted to a base via front and rear pivot arms, enabling deployment from a stored position to a position below and outward from the stored position to allow workers ground-level access to road work equipment. The base is configured for mounting along a side edge of a vehicle bed to maintain open space in the central portion of the truck bed. The system includes a torsion spring mechanism providing lift assist when moving the storage box from the deployed to stored position, with the spring being neutral when the rear pivot arm is vertical. A pivotable safety bar extends over the top of the storage bins and is spring biased to a protective position. The front and rear pivot arms align to create a bottom travel limit in the deployed position. The multi-bin configuration provides organized storage for road signs and sign stands while enabling safe access by workers standing at ground level beside the truck bed.

### CROSS REFERENCE TO RELATED APPLICATIONS

This application claims the benefit of U.S. Provisional Ser. No. 63/687,545 titled “VEHICLE-MOUNTED DROP-DOWN STORAGE SYSTEM,” filed by the inventor herein on Aug. 27, 2024, the specification of which is incorporated herein by reference in its entirety.

### FIELD OF THE INVENTION

The present invention relates generally to storage systems for mobile vehicles, and more particularly to storage systems for road-work vehicles configured to provide safe and easy access to road work equipment, such as road signs and road sign stands, and an efficient storage system for such road work equipment that maximizes open space on the truck bed of a road-work vehicle.

### BACKGROUND OF THE INVENTION

Road crews are frequently called upon to perform various road repair and maintenance operations in traffic conditions. Those operations typically require that a road work crew retrieve large signs and sign stands from storage on the work vehicle, and place them on the road to direct traffic, exposing them to direct road traffic around the work zone. Such operations can be quite dangerous for the road crew. For example, if the road crew walks behind or along the traffic side of the vehicle while pulling off road signs and sign stands, they are directly exposed to risk of being struck by oncoming traffic. If members of the road crew stand on the platform of a typical work truck to retrieve and place such stands and signs, they are forced to excessively bend down to be able to retrieve and place them on the road surface.

To best protect against the risk of being struck by oncoming traffic, road crews would be best situated by being able to both easily access road signs and stands stored on the vehicle and place them on the road surface without such excessive bending and without being exposed to oncoming traffic. While some prior efforts have been made to improve a vehicle-born worker's ability to retrieve from storage and place various road work equipment on the road surface, such efforts are lacking in simultaneously providing efficient storage in combination with easy access to road signs and stands that are stored on the vehicle. Thus, there remains a need in the art for storage systems configured for road work equipment that provide safe access while maintaining maximum truck bed utility.

### SUMMARY OF THE INVENTION

In accordance with certain aspects of an embodiment of the invention, a vehicle-mounted drop down storage system is provided comprising a sign storage cabinet and a deployable storage container having a multi-bin storage box pivotably mounted to a base via front and rear pivot arms, enabling deployment to a position below and outward from the stored position for safe ground-level access to road work equipment.

In one embodiment, the system includes a torsion spring mechanism providing lift assist, a pivotable safety bar preventing equipment from falling out of the storage container, and a spring cable latch system for door control. The configuration maintains open space in the central portion of the truck bed while providing organized storage for road signs and sign stands.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a perspective view of the vehicle-mounted drop-down storage system having a sign storage cabinet and a deployable multi-bin storage container in accordance with certain aspects of an embodiment of the invention, installed on a truck bed;

FIG. 2 is a front perspective view of a deployable storage container according to further aspects of an embodiment of the invention, shown in the stored position;

FIG. 3 is a front view of the deployable storage container of FIG. 2;

FIG. 4 is a top view of the deployable storage container of FIG. 2;

FIG. 5 is a side view of the deployable storage container of FIG. 2;

FIG. 6 is a rear perspective view of the deployable storage container of FIG. 2;

FIG. 7 is a side perspective view of the vehicle-mounted drop-down storage system of FIG. 1 showing the deployable storage containers in the stored position and ready for deployment:

FIG. 8 is another side perspective view of the vehicle-mounted drop-down storage system of FIG. 1 showing a first deployable storage container in the deployed position and a second deployable storage container in the stored position;

FIG. 9 is a perspective view of the left base plate for mounting a deployable storage container of FIG. 2 to a truck bed;

FIG. 10 is a perspective view of the right base plate for mounting a deployable storage container of FIG. 2 to a truck bed; and

FIG. 11 is a close-up front view of a door of the deployable storage container of FIG. 2.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Disclosed herein is a system for efficiently storing on, and easily accessing road signs and road sign stands from, a work vehicle, and more particularly from the bed of a work vehicle. Systems configured in accordance with at least certain aspects of the invention may enable work crews to improve organization of and access to signs and sign stands in the back of their truck beds by enabling workers to store each sign and stand safely and securely in its own designated spot on the bed while retaining ready and safe accessibility to them. With a storage system configured as disclosed herein, there is no need for the work crew to pile or dig through equipment as is traditionally done on such work vehicles.

Moreover, systems configured in accordance with at least certain aspects of the invention strategically position storage cabinet doors and stand boxes on both sides of the vehicle, such that workers have access to signs and stands while being shielded by the vehicle in all normal traffic circumstances. The location and configuration of the storage system, and particularly of the deployable sign stand storage bin and the multi-door sign storage cabinets, allow safe access to road signs and sign stands, and any other equipment stored therein, during set up. Road signs may be accessed from the front and the back of the sign storage cabinets, and the sign stands may be accessed by a worker on the ground, next to the truck bed, from the safe (i.e., non-traffic) side of the work truck. Such equipment remains easily accessible without requiring the worker to climb into the truck bed. A safety bar system may be provided to keep all stored equipment secure while travelling to and from a work zone, and to prevent equipment from falling onto personnel. Moreover, systems configured in accordance with at least certain aspects of the invention are quite versatile, in that the system may be easily removed when unneeded for a given road work job to create more storage space on the truck bed, but likewise easily installed when such storage system is desired.

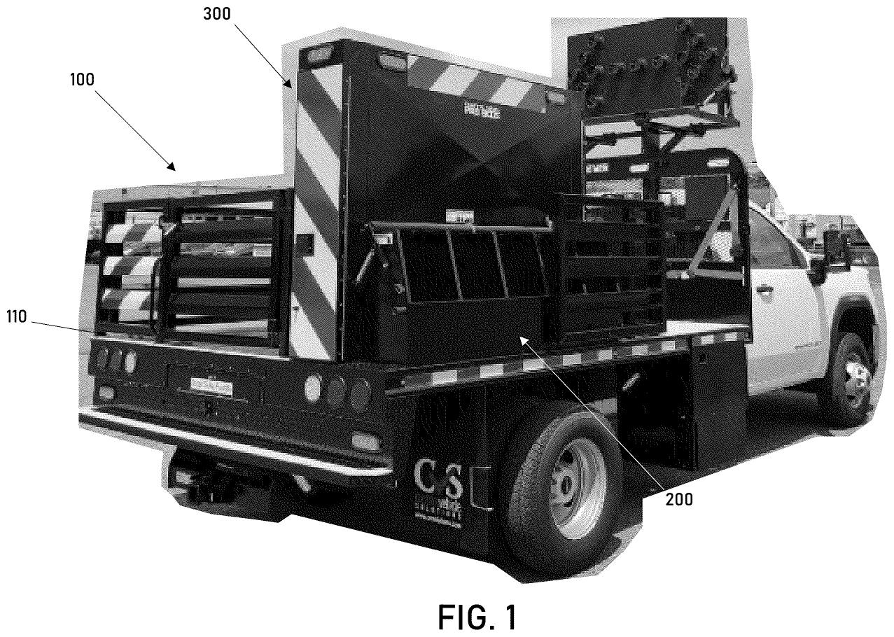

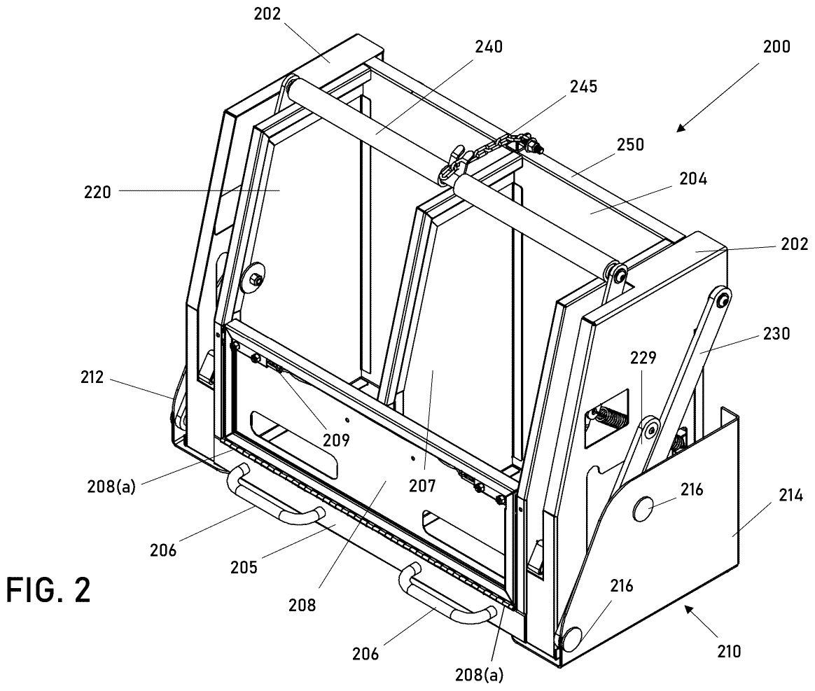

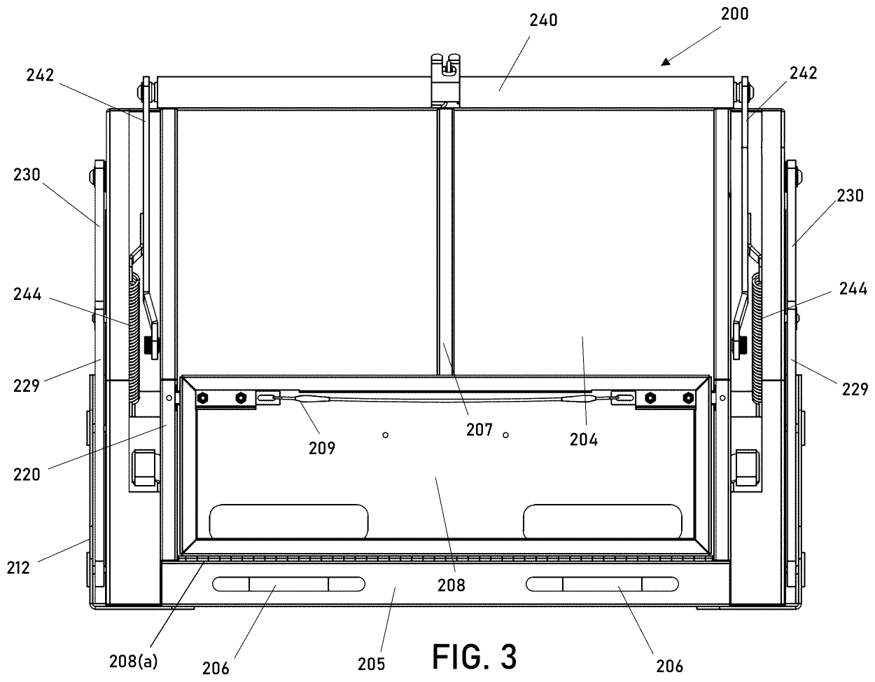

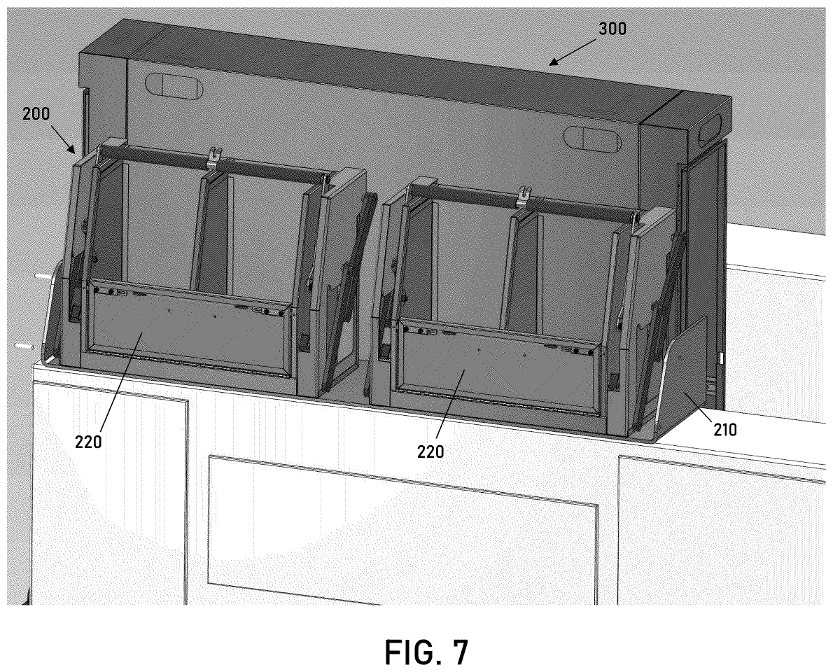

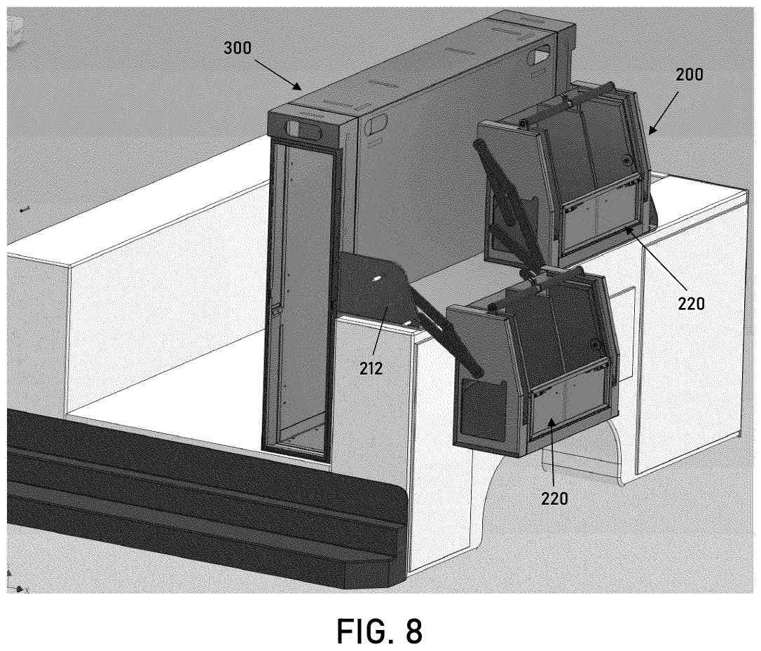

In accordance with certain aspects of an embodiment of the invention and with particular reference to FIG. 1, a vehicle-mounted road sign and sign stand storage system 100 is provided having a deployable storage container 200 and storage cabinet 300, both of which are affixed to the bed 110 of a road work truck. With continuing reference to FIG. 1 and the detailed views of FIGS. 2-6, deployable storage container 200 comprises a base 210 that may be affixed to the truck bed 110 via bolts, screws, or similarly configured fasteners, and multi-bin storage box 220 that is pivotably mounted to base 210, enabling pivoting of multi-bin storage box 220 outward and downward from base 210 (as shown in FIGS. 7 and 8) such that a worker standing on the ground and next to the side of the work vehicle (on the side of the vehicle that is not exposed to traffic) may reach into and remove items, such as road sign stands, positioned in multi-bin storage box 220 without having to lift them over the worker's head. Moreover, as the deployable storage container 200 and fixed storage cabinet 300 are positioned along the side edges of the bed of the work vehicle, open space is maintained in the central portion of the bed of the vehicle enabling storage of additional road equipment, such as traffic cones and the like.

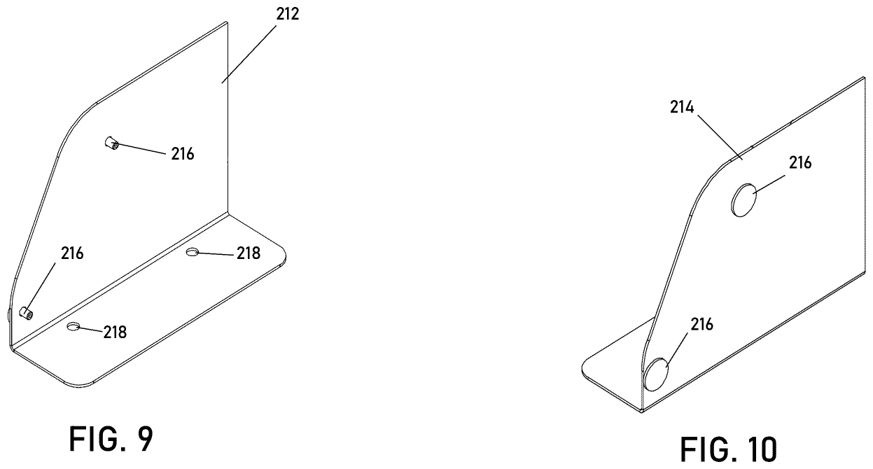

FIGS. 9 and 10 show close-up views of the components of base 210, namely, left base plate 212 (FIG. 9) and right base plate 214 (FIG. 10), which is a mirror copy of left base plate 212. Each of left base plate 212 and right base plate 214 include pivot rod weldments 216 configured to pivotably mount front pivot arms 229 and rear pivot arms 230, which in turn are mounted to the side panels of multi-bin storage box 220, as discussed in greater detail below, to allow multi-bin storage box 220 to pivot outward and downward from base 210 and the portion of the truck bed 110 on which base 210 is mounted. Each of left base plate 212 and right base plate 214 may also be provided connector openings 218 configured to receive a screw, bolt, or similarly configured connector that may likewise extend into and/or through truck bed 110 to affix left base plate 212 and right base plate 214 to the truck bed 110. Alternatively, in certain configurations (such as where multiple multi-bin storage boxes 220 are to be provided adjacent to one another), base 210 may include a continuous flat panel extending below multiple adjacent multi-bin storage boxes 220.

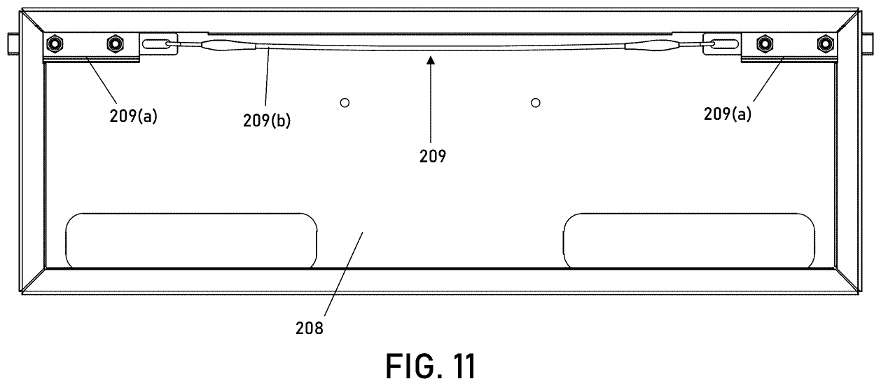

Multi-bin storage box 220 comprises side panels 202, back panel 204, front panel 205, and one or more intermediate wall panels 207 that define one or more bins inside of multi-bin storage box 220. Preferably, handles 206 are provided on front panel 205 to assist in moving multi-bin storage box 220 from its stored position to an accessible position outward and downward from the stored position. Multi-bin storage box 220 may also include a hinged door 208 extending over the bottom portion of the individual bins. Hinged door 208 is mounted along a bottom hinge 208(a) to multi-bin storage box 220, such that it may be swung downward and outward to expose the full open portion of each bin, enabling easy access to each bin. With particular reference to FIG. 11, a spring cable latch 209 may be provided to allow locking engagement of door 208 to side panels 202. In this regard, spring cable latch 209 includes spring-biased, sliding latch members 209(a) and cable 209(b) that engages each sliding latch member 209(a), such that pulling downward on cable 209(b) releases each sliding latch member 209(a) from its respective side panel 202, allowing hinged door 208 to be swung downward for access to the bins of multi-bin storage box 220.

A moveable safety bar 240 extends over the tops of the bins of multi-bin storage box 220 and is pivotably mounted to each side panel 202 to, when positioned overtop of multi-bin storage box 200, maintain sign stands or other items in the multi-bin storage box 220 from accidentally falling forward and/or out of multi-bin storage box 220, and that may easily pivot downward to allow free access to the bins for removal of such items. More particularly, moveable safety bar 240 is pivotably mounted inside of each side panel 202 via pivot arms 242 to allow safety bar 240 to pivot outward and away from the top of the bins of multi-bin storage box 220. Preferably, a spring 244 is affixed to an outward extending flange of each pivot arm 242 to bias safety bar 240 to its top position extending over the bins of multi-bin storage box 200. Further, a safety chain 245 may be provided to lock the safety bar 240 at its uppermost position extending over the bins of multi-bin storage box 220.

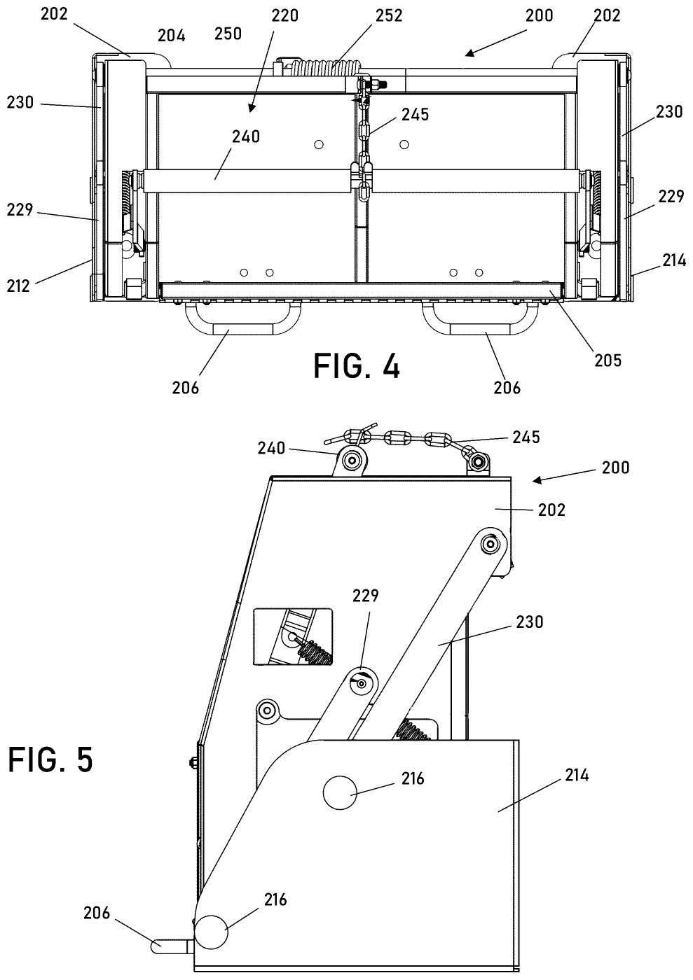

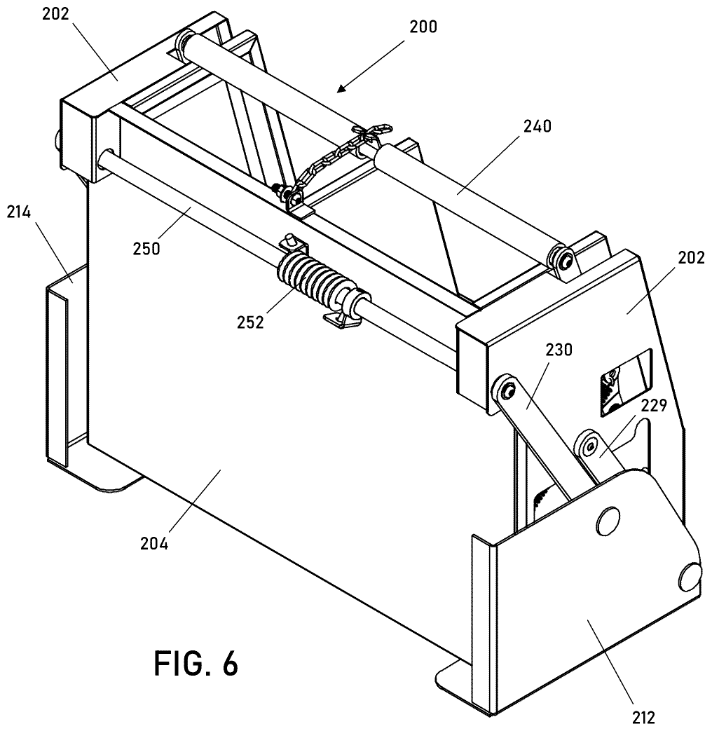

As noted above, multi-bin storage box 220 is pivotable outward and downward from base 210 via front pivot arm 229 and rear pivot arm 230. Preferably, a pivotable spring core pipe weldment 250 is affixed to each rear pivot arm 230 and extends through each side panel 202 to pivot with rear pivot arms 230. A torsion spring 252 (FIGS. 4 and 6) is mounted to spring core pipe weldment 250 and back panel 204 of multi-bin storage box 220 to provide a lift assist when a worker lifts a full multi-bin storage box 220 from its deployed position to its stowed travel position. In this regard, as multi-bin storage box 220 pivots outward and downward from base 210, torsion spring 252 exerts a biasing force that biases multi-bin storage box 220 upward, and more particularly biases rear pivot arm 230 to a vertical orientation, thus assisting a user when lifting multi-bin storage box 220 back to its stored position. As torsion spring 252 is neutral when rear pivot arm 230 is in a vertical orientation, torsion spring 252 additionally provides a lift assist to start movement when multi-bin storage box 220 is initially pulled from its stored position.

Both front pivot arm 229 and rear pivot arm 230 are aligned and come together to create the bottom travel limit of multi-bin storage box 220.

The foregoing configuration offers a number of advantages; namely, (i) the system configuration leaves space available in the center of the truck bed for storage of various work items; (ii) the system configuration minimizes the storage footprint in the stowed, travel position; and (iii) the deployable storage bin 200 deploys to a lowest access position that is both below the stored position and along the side of the vehicle truck bed, with the back wall of the multi-bin storage box 220 parallel to the sidewall of the truck bed, allowing ease of access to the work items stored in the bins of multi-bin storage box 220.

To install the deployable storage container 200, a worker may employ the following steps. First, the distance between the base plates 212 and 214 is set and the base plates 212 and 214 are fastened down to the side edges of the truck bed. Next, the front pivot arms 229 and the rear pivot arms 230 are installed on each of the base plates 212 and 214. Next, the multi-bin storage box 220 is placed in position and the front pivot arms 229 and rear pivot arms 230 are fastened to the side panels 202 of the multi-bin storage box 220. Finally, the multi-bin storage box 220 is deployed to test movement and ensure that the multi-bin storage box 220 clears the edge of the truck body.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A vehicle-mounted drop-down storage system comprising:
a base configured for mounting to a vehicle bed;
a multi-bin storage box having a plurality of individual storage bins separated by intermediate wall panels;
front and rear pivot arms pivotably connecting said multi-bin storage box to said base, wherein said front and rear pivot arms are mounted to pivot said multi-bin storage box outward and downward from a stored position to a deployed position below and laterally offset from said stored position; and
a torsion spring mechanism operatively connected to said rear pivot arm and configured to provide lift assist when moving said multi-bin storage box from said deployed position to said stored position.

2. The system of claim 1, further comprising a pivotable safety bar extending over tops of said plurality of storage bins and pivotably mounted to side panels of said multi-bin storage box.

3. The system of claim 2, wherein at least one spring biases said pivotable safety bar to a protective position over said storage bins.

4. The system of claim 1, further comprising a hinged door extending over a bottom portion of said plurality of storage bins and mounted via a bottom hinge to said multi-bin storage box.

5. The system of claim 4, further comprising a spring cable latch system having spring-biased sliding latch members and a cable operatively connected thereto for releasing said hinged door.

6. The system of claim 1, wherein said torsion spring mechanism comprises a pivotable spring core pipe weldment affixed to said rear pivot arm and extending through side panels of said multi-bin storage box.

7. The system of claim 1, wherein said base comprises left and right base plates each including pivot rod weldments that pivotably mount said front and rear pivot arms.

8. The system of claim 1, wherein said front and rear pivot arms are configured to align and create a bottom travel limit for said multi-bin storage box in said deployed position.

9. The system of claim 1, wherein said multi-bin storage box includes handles on a front panel to assist in moving between said stored and deployed positions.

10. The system of claim 1, wherein said base is positioned along a side edge of said vehicle bed to maintain open space in a central portion of said vehicle bed.

11. A vehicle-mounted storage system for road work equipment comprising:
a base assembly configured for attachment to a truck bed along a side edge thereof;
a multi-compartment storage container having a plurality of individual bins defined by intermediate divider walls;
a dual pivot arm assembly including front and rear pivot arms connecting said storage container to said base assembly;
said dual pivot arm assembly being pivotably mounted to deploy said storage container from a stowed position within said truck bed to an accessible position below truck bed level and laterally outward from said truck bed; and
a spring-assisted lifting mechanism operatively connected to said rear pivot arm and configured to bias said storage container toward said stowed position.

12. The system of claim 11, further comprising a safety retention system including a pivotable safety bar positioned over said plurality of bins and spring-biased to a retention position over said plurality of bins.

13. The system of claim 11, further comprising a door system including a hinged access door and a spring cable latch mechanism for selective door release.

14. The system of claim 11, wherein said spring-assisted lifting mechanism comprises a torsion spring having a neutral position when said rear pivot arm is substantially vertical.

15. The system of claim 11, wherein said front and rear pivot arms are pivotably mounted to contact each other to define a maximum deployment angle.

16. The system of claim 11, wherein said base assembly maintains open space in a central region of said truck bed when said storage container is in said stowed position.

17. The system of claim 11, wherein said accessible position positions said storage container for ground-level access by a worker standing beside said truck bed.

18. The system of claim 11, further comprising a sign storage cabinet mounted on said truck bed adjacent to said base assembly and inward on said truck bed from said base assembly.

19. A method of storing and accessing road work equipment comprising:
providing a multi-bin storage system mounted along a side edge of a truck bed;
storing road work equipment in individual bins of said multi-bin storage system while said system is in a stowed position;
deploying said multi-bin storage system by pivoting said multi-bin storage system outward and downward via coordinated front and rear pivot arms to position said bins below truck bed level for ground access; and
accessing said road work equipment from said bins while standing on ground level beside said truck bed.

20. The method of claim 19, further comprising activating a spring-assisted lift mechanism to aid in returning said multi-bin storage system to said stowed position.
